(19) United States
(12) Patent Application Publication
(10) Pub. No.: US 2013/0279693 A1
(43) Pub. Date: Oct. 24, 2013

(54) TRANSMITTING A SIGNAL BASED ON A HIGH-DEFINITION MULTIMEDIA INTERFACE SIGNAL

(71) Applicant: Leigh M. Rothschild, Sunny Isles Beach, FL (US)

(72) Inventor: Leigh M. Rothschild, Sunny Isles Beach, FL (US)

(73) Assignee: Ariel Inventions, LLC, Sunny Isles Beach, FL (US)

(21) Appl. No.: 13/454,339

(22) Filed: Apr. 24, 2012

(51) Int. Cl. H04N 7/01; H04N 7/167

(52) U.S. Cl. 380/200; 348/441; 348/E07.003

(57) ABSTRACT

A method and a device for receiving a High-Definition Multimedia Interface (HDMI) signal from an HDMI source via a first HDMI interface is disclosed. The HDMI signal includes data in a first format. The data is converted to a second format and transmitted wirelessly to a wireless device. The HDMI signal is transmitted to an HDMI destination via a second HDMI interface.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to wireless communication and in particular to a method and system for wirelessly transmitting data based on a received High-Definition Multimedia Interface (“HDMI”) signal.

### BACKGROUND OF THE INVENTION

Consumers can access audio and video content through media sources such as satellite dishes and cable boxes. Satellites transmit television programming using signals that contain audio and video data. These signals are sent from a communication satellite to a satellite dish installed on the consumer's home. The satellite dish is in communication with a receiver which in turn is connected to a television in the consumer's home. Similarly, cable television provides television programming using coaxial cables or digital light pulses through optical fibers on the consumer's property. The audio and video data travels through cables connected to the receiver which is coupled to a television set or a multimedia audio/visual receiver.

In addition to a satellite dish and a cable box, other kinds of media sources may provide media content. Media sources include a personal video recorder, a digital video recorder (“DVR”), a Digital Versatile Disc (“DVD”) player, A Blue-ray player, a Videocassette Recorder (“VCR”), etc, among others. Some media sources can transmit audio and video data using a High-Definition Multimedia Interface (“HDMI”) connection. The data may be sent via HDMI to an HDMI compatible device, such as an HDMI compatible television, an audio video receiver (“A/V receiver”), etc.

Multimedia interfaces provide compact audio and video transmission of encrypted digital data. For example, a multimedia interface may be an HDMI that can carry audio and video between a source and a destination device in compliance with the High-bandwidth Digital Content Protection (“HDCP”) security feature. HDCP prevents the copying of the audio and video data as it propagates to an HDMI compatible device. Before sending audio and video data to the destination device, an HDCP enable media source verifies that the destination device is authorized to receive the data. If the destination device is authorized to receive data via HDMI, the media source encrypts the data using HDCP to prevent eavesdropping as it flows to the destination device. The destination device may use a unique set of keys to decrypt the HDCP encrypted data sent by the media source.

Consumers usually watch satellite and cable television at their home. When the consumer is not at home, data from the media source may be streamed via the Internet to a computer proximate to the consumer. For example, the consumer may use a streaming device to stream data from a media source at home, such as the cable box or satellite, to a computer connected to the Internet. Streaming devices offer consumers the opportunity to watch local television programming from anywhere in the world using a computer connected to the Internet.

The streaming media device encodes audio and video data received from a media source, such as a cable box, a satellite dish, a personal video recorder, DVR, DVD players, VCRs, etc., for transmission over the Internet. Even though streaming devices are popular among consumers, currently there are no streaming devices that are configured to receive data from media sources that output HDCP encrypted data via HDMI, and wirelessly transmit the audio and video data to a wireless device.

### SUMMARY OF THE INVENTION

A method and system for receiving a first signal from a source is disclosed. In accordance with one aspect, a first signal is received from the source via a first interface. The first signal includes data in a first format. The data is converted to a second format and transmitted wirelessly to a wireless device. The first signal is transmitted to a multimedia destination via a second interface.

In accordance with another aspect, the present invention provides a device having a first multimedia interface, a processor, a wireless transmitter and a second multimedia interface. The processor is in communication with the first multimedia interface, the wireless transmitter and the second multimedia interface. The first multimedia interface is configured to receive a first multimedia signal from a multimedia source. The first multimedia signal includes data in a first format. The processor converts the data to a second format. The wireless transmitter wirelessly transmits the converted data to a wireless device. The second multimedia interface is configured to transmit the multimedia signal for receipt by a multimedia destination.

According to another aspect, the invention provides a computer readable storage medium storing computer readable instructions that, when executed by a processor cause the processor to perform a method. The method includes receiving a High-Definition Multimedia Interface (HDMI) signal from an HDMI source via a first HDMI interface. The HDMI signal includes data in a first format. The data is converted to a second format and is transmitted wirelessly to a wireless device. The HDMI signal is transmitted to an HDMI destination via a second HDMI interface.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention;

FIG. 2 is a block diagram of an exemplary device constructed in accordance with the principles of the present invention;

FIG. 3 is a flow chart of an exemplary process for wirelessly transmitting a signal based on an HDMI signal, in accordance with the principles of the present invention; and

FIG. 4 is a flow chart of an exemplary process for wirelessly receiving a signal based on an HDMI signal, in accordance with the principles of the present invention.

### DETAILED DESCRIPTION OF THE INVENTION

Embodiments of the present invention provide a method and system for receiving data via HDMI and wirelessly transmitting the data to a computing device while still allowing the HDMI signal to be transmitted to the destination HDMI compatible device. In accordance with an embodiment of the present invention, an HDMI signal from an HDMI source is received via a first HDMI interface. The signal includes data in a first, e.g., HDMI compatible, format. The data is converted to a second format and it is wirelessly transmitted to a wireless device. The HDMI signal is transmitted to an HDMI destination via a second HDMI interface. In one embodiment, the system of the present invention supports HDCP such that the device can complete the HDCP “handshake”, thereby allowing received encrypted HDMI data to be wirelessly transmitted to a portable or other wireless device.

Before describing in detail exemplary embodiments that are in accordance with the present invention, it is noted that the embodiments reside primarily in combinations of apparatus components and processing steps related to implementing a method and system for receiving data via a first interface, such as an HDMI interface, and transmitting the data to a wireless device via a wireless network. Accordingly, the method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

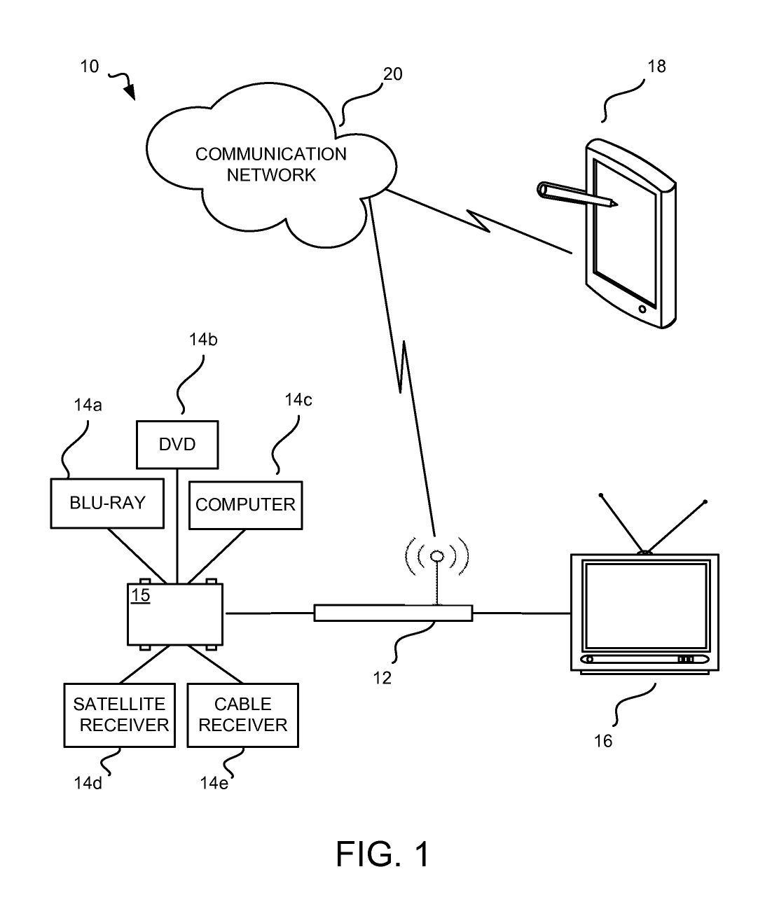

Referring now to the drawing figures in which reference designators refer to like elements, there is shown in FIG. 1 a schematic illustration of a system in accordance with the principles of the present invention, and generally designated as “10.” As shown in FIG. 1, a device 12 may be connected to an HDMI source. Examples of HDMI sources include, but are not limited to, a Blue-Ray player 14a, a Digital Versatile Disc (“DVD”) player 14b, a computer 14c, a satellite receiver 14d and a cable receiver 14e, among other devices, via A/V receiver 15. HDMI sources 14a-14e are herein referred collectively as “HDMI source 14”. Device 12 may also be connected to HDMI destination 16. Additionally, device 12 may be in communication with wireless device 18 via wireless network 20. Wireless device 18 may be a mobile device, personal computer, laptop computer, tablet computer, PDA, among other types of computing devices. In an exemplary embodiment, device 12 receives data from HDMI source 14 via a first multimedia interface, which may be a first HDMI interface to device 12. The data may be encrypted using HDCP. Device 12 may decrypt the data and send the data wirelessly to wireless device 18 via communication network 20. Device 12 may also act as a pass-through device passing the HDMI signal from HDMI source 14 to HDMI destination 16 via a second multimedia interface, such as a second HDMI interface.

Communication network 20 may include a cellular communication network and the Public Switched Telephone Network (PSTN), or other wide area network (WAN), such as the Internet, as well as local area networks (LANs), such as an Ethernet LAN. Communication network 20 may be a wireless network, such as Wi-Fi, satellite, infrared, Bluetooth, Near Field Communications, or other communication network. Device 12 and wireless device 18 may be connected via communications network 20 to other computers, such as computers associated with a media company, a cable service or any other third party (not shown).

Although FIG. 1 shows HDMI source 14 connected to device 12 via A/V receiver 15, HDMI source 14 may be connected directly to device 12. In addition to devices 14a-14e, HDMI source 14 may also include a personal video recorder, a Videocassette Recorder (“VCR”), a High Definition DVD player, an Advanced Video Coding High Definition (“AVCHD”) camcorder, a mobile device, a video game console, a High Definition cable box, a High Definition satellite box, a digital video player, a set-top box, etc., among others.

Device 12 may be compatible with high-bandwidth interfaces such as Digital Visual Interface (“DVI”), HDMI, Unified Display Interface (“UDI”), Giga-bit Video Interface (“GVIF”), Digital Light Interface (“DLI”), DisplayPort, High Definition Base Technology (“HDBaseT”), Mobile High Definition Link (“MHL”), Gigabit Multimedia Serial Link (“GMSL”), Flat Panel Display Link Third Generation (“FPD-Link III”), Automotive PIXel Link (“APIX”), among others.

HDMI source 14 may support two-way communication between HDMI source 14 and device 12, which may allow automatic configuration of device 12. For example, the two-way communication may enable device 12 to choose a video format that may properly display data on HDMI destination 16, such as a consumer's television. Additionally, the two-way communication may allow HDMI source 14 and device 12 to exchange profile information so that the data may be transmitted between HDMI source 14 and device 12 without requiring a consumer to set up proper audio and video formats.

HDMI source 14 may send a first signal, such as an HDMI signal including audio and video data to device 12 via an HDMI interface. Data may include, but is not limited to compressed data, uncompressed data, data encoded with linear pulse-code modulation, auxiliary data, extended display identification data, etc. In an exemplary embodiment, HDMI source 14 and device 12 may be connected through a first HDMI interface. First HDMI interface may be a protected interface, such as an HDCP protected interface. HDMI source 14 may send to device 12 audio and video data encrypted with a security protocol, such as HDCP. Device 12 may be licensed to receive data encrypted with HDCP via HDMI. Device 12 may also be configured to receive (i) previously HDCP-encrypted content that has subsequently been decrypted and (ii) content that has never been encrypted with HDCP.

Device 12 may authenticate with HDMI source 14 before receiving data via HDMI. During authentication, HDMI source 14 may verify that device 12 is authorized to receive data via HDMI, using for example, HDCP. Device 12 may send verification data/identification information associated with a first set of unique device keys to HDMI source 14. HDMI source 14 may analyze the verification data/identification information and determine that device 12 is licensed to receive data via HDMI. Once authentication is established, HDMI source 14 may send encrypted data via the first HDMI interface to device 12.

Device 12 may be configured to decrypt the encrypted HDCP data. Device 12 may use the set of unique device keys that may include a cryptographic value to decrypt the data. Device 12 may convert the HDMI data from a first, e.g., HDMI, format to a second, e.g., TCP/IP format, and may send the converted data to wireless device 18. In an exemplary embodiment, device 12 may send the decrypted data wirelessly to wireless device 18. Wireless device 18 may be configured to receive the decrypted data. Additionally, device 12 may send the HDMI signal received from HDMI source 14 to HDMI destination 16 via a second HDMI interface.

In an exemplary embodiment, device 12 may act as an HDCP stripper and may remove HDCP information from the data before sending the data to other devices, such as wireless device 18. Device 12 may perform some signal processing, such as for example splitting the audio portion of the data from the video portion or converting the data from a first format to a second format compatible with wireless device 18. Device 12 may send the data to multiple devices, such as multiple screens for simultaneous display. In another exemplary embodiment, device 12 may act as a repeater that transmits the encrypted data to other devices. Device 12 may transmit the encrypted data to wireless device 18 using HDCP security. Wireless device 18 may be a HDMI compatible computer and may be configured to authenticate with the source and decrypt HDCP encrypted data. Device 12 may transmit the encrypted data wirelessly to wireless device 18. A typical known wireless device that is configured to receive HDMI signals has a physical HDMI interface. In contrast, in an exemplary embodiment herein, device 12 may transmit a signal, based on a HDMI signal, to wireless device 18 even though wireless device 18 does not have a HDMI interface, given that device 12 converts HDMI signals into a second format that is compatible with wireless device 18. In an exemplary embodiment, the converted signal may be a signal compatible with the Institute of Electrical and Electronics Engineers (“IEEE”) 802.11 wireless standard. Device 12 transmits the formatted signal to wireless device 18.

HDMI source 14 may also send data to HDMI destination 16, which may be configured to process data sent via the second HDMI interface. HDMI destination 16 may include, but is not limited to a digital television, an analog television, a video projector, a computer monitor, a High Definition Television (“HDTV”), a Digital Visual Interface (“DVI”) receiver, a video/audio monitor, etc. among others. HDMI destination 16 may include an HDMI input port. Device 12 may simultaneously send data from HDMI source 14 to both HDMI destination 16 and wireless device 18.

HDMI destination 16 may authenticate with device 12 before receiving data via HDMI. During authentication, device 12 may verify that HDMI destination 16 is authorized to receive data via HDMI, using for example, HDCP. Device 12 may receive verification data/identification information associated with a second set of unique device keys from HDMI destination 16. Device 12 may analyze the verification data/identification information and determine that HDMI destination 16 is licensed to receive data via HDMI. Once authentication is established, device 12 may send the HDMI signal via the second HDMI interface to HDMI destination 16.

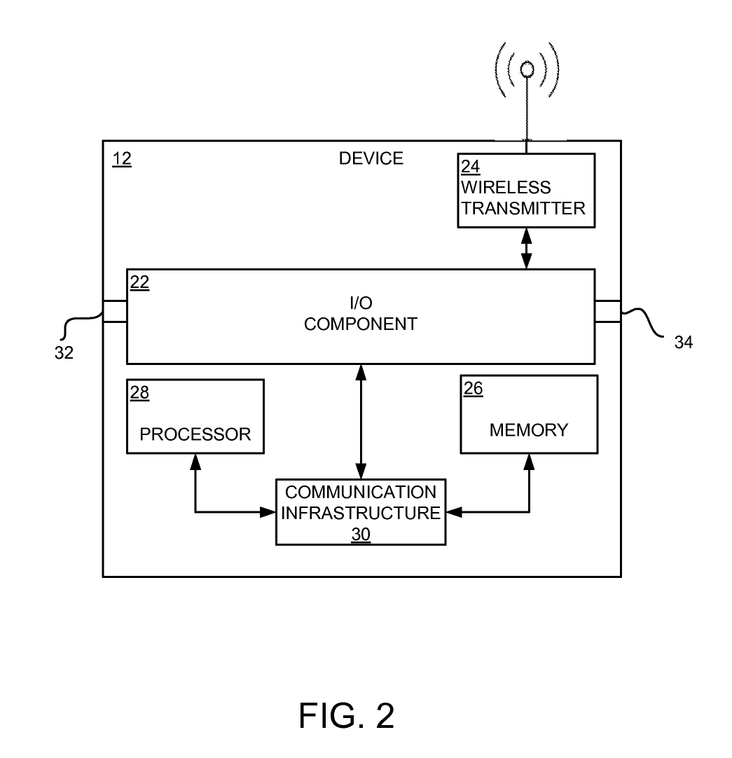

FIG. 2 is a block diagram of an exemplary device 12 constructed in accordance with the principles of the present invention. Device 12 may include input/output component 22, wireless transmitter/receiver 24, memory 26 and processor 28, connected via communication infrastructure 30, e.g., a communications bus, cross-bar interconnect, network, etc. Processor 28 may include a central processing unit (CPU) programmed to perform the functions described herein with respect to device 12. Processor 28 may be configured to encrypt and decrypt HDCP data.

Processor 28 may convert data received in a first format to a second format. Wireless transmitter/receiver 24 may transmit the converted data to wireless device 18. Processor 28 may initiate downloads to update software implementations of HDCP via communication network 20. I/O component 22 may include first HDMI interface 32 and second HDMI interface 34. Device 12 may use I/O component 22 for communicating with HDMI source 14 via first HDMI interface 32, and HDMI destination 16 via second HDMI interface 34. Device 12 may use wireless transmitter 24 to communicate with wireless device 18, among other devices. Device 12 may communicate with wireless device 18 via communications network 20 wirelessly or by wire or optical fiber. In an exemplary embodiment, device 12 may exercise control HDMI source 14 and HDMI destination 16.

Memory 26 may include random access memory (“RAM”) and read only memory (“ROM”). Memory 26 may store identification information associated with wireless device 18. Computer programs (also called computer control logic) may be stored in memory 26. For example, computer programs are stored on memory 26 for execution by processor 28. Such computer programs, when executed, enable the method and system to perform the features of the present invention as discussed herein. In particular, the computer programs, when executed, enable processor 28 to perform the features of the corresponding method and system. Accordingly, such computer programs represent controllers of the corresponding device.

In an exemplary embodiment, I/O component 22 may receive from HDMI source 14 data via first HDMI interface 32. The data may be encrypted using HDCP. Processor 28 may act as a key generator to generate device keys for authentication, encryption and decryption of data. Processor 28 may associate numerical values with a device key set to support authentication with HDMI source 14. Processor 28 may initiate authentication procedures with HDMI source 14. I/O component 22 may send data, such as authentication data, to HDMI source 14, in order for HDMI source 14 to verify that device 12 is configured/authorized to send and receive data via HDMI. I/O component 22 may receive from HDMI source 14 a verification message via first HDMI interface 32. I/O component 22 may receive from HDMI source 14 data encrypted using HDCP. Processor 28 may format the data received in one format to a second format. Converting the data may include decrypting the data. Wireless transmitter 24 may transmit the data to, for example, wireless device 18.

In another exemplary embodiment, processor 28 may not decrypt the received data and may send the encrypted data to wireless device 18 using wireless transmitter 24. For example, the data sent to wireless device 18 may be encrypted with HDCP. Wireless device 18 may be configured to receive data via HDMI. Wireless transmitter 24 may also send data to an apparatus that may or may not be configured to receive data via HDMI. In another exemplary embodiment, processor 28 may remove the HDCP protection of the data. Wireless transmitter 24 may transmit the data without HDCP protection to wireless device 18. Processor 28 may also be configured to convert data to a different format, such as DVI or Moving Picture Experts Group (“MPEG”) format. Processor 28 may convert the data received in a first format to a second format compatible with wireless device 18. Processor 18 may convert the data to a format usable by wireless device 18, such as MPEG4, Audio Video Interleave (“AVI”), Web Mapping Service (“WMS”), etc. The converted data may be transmitted to wireless device 18.

In another exemplary embodiment, device 12 may be in communication with HDMI destination 16 via second HDMI interface 34. Device 12 may act as a pass through device to HDMI destination 16. I/O component 22 may transmit data received from HDMI source 14 to HDMI destination 16 via second HDMI interface 34. The data may be encrypted using HDCP. Processor 28 may associate numerical values with a device key set to support authentication with HDMI destination 16. Processor 28 may initiate authentication operations with HDMI destination 16. Alternatively, HDMI destination 16 may initiate authentication operations with device 12.

I/O component 22 may send authentication data to HDMI destination 16, so that HDMI destination 16 can verify that device 12 is configured to send and receive data via HDMI. I/O component 22 may receive from HDMI destination 16 a verification message via first HDMI interface 34. I/O component 22 may receive authentication data from HDMI destination 16, so that device 12 may verify that HDMI destination 16 is configured to send and receive data via HDMI. Processor 28 may encrypt the data using HDCP. I/O component 22 may send encrypted data to HDMI destination 16 via second HDMI interface 34.

In another exemplary embodiment, device 12 may require wireless device 18 to authenticate with device 12 in order to receive data from device 12. Device 12 may store in memory 26 computer identification data associated with wireless devices authorized to receive data from device 12. During authentication, wireless device 18 may send to device 12 identification data associated with wireless device 18. Processor 28 may access memory 26 to determine whether the identification data corresponds to identification data stored in memory 26. For example, if the processor determines that the identification data matches one of the computer identification data stored in memory 26, device 12 may skip login/authentication procedures with wireless device 18. Else, processor 28 may initiate login procedures to determine whether wireless device 18 is authorized to receive data from device 12. If processor determines that wireless device 18 is authorized, device 12 may start transmitting data to wireless device 18. The identification data associated with wireless device 18 may be stored in memory 26 for future reference. If wireless device 18 is not authorized to receive data from device 12, processor 28 may command wireless transmitter 24 to not send data to wireless device 18.

In another exemplary embodiment, wireless device 18 may be a wireless mobile device that receives data from device 12. The wireless device 18 may include a mobile application configured to authenticate the wireless mobile device with device 12. The mobile application may be stored in the wireless device 18 or may be accessed via the Internet. The mobile application may decrypt data received by the wireless device 18. For example, the mobile application may decrypt HDMI data encrypted using HDCP. The mobile application may decrypt the data using decryption algorithms. Alternatively, device 12 may send already decrypted data to the wireless device 18. The data may be in a format usable by the wireless device 18.

It is understood that computer systems and/or computer architectures other than those specifically described herein can be used to implement the invention. It is also understood that the capacities and quantities of the components of the architecture described herein may vary depending on the device, the quantity of devices to be supported, as well as the intended interaction with the device.

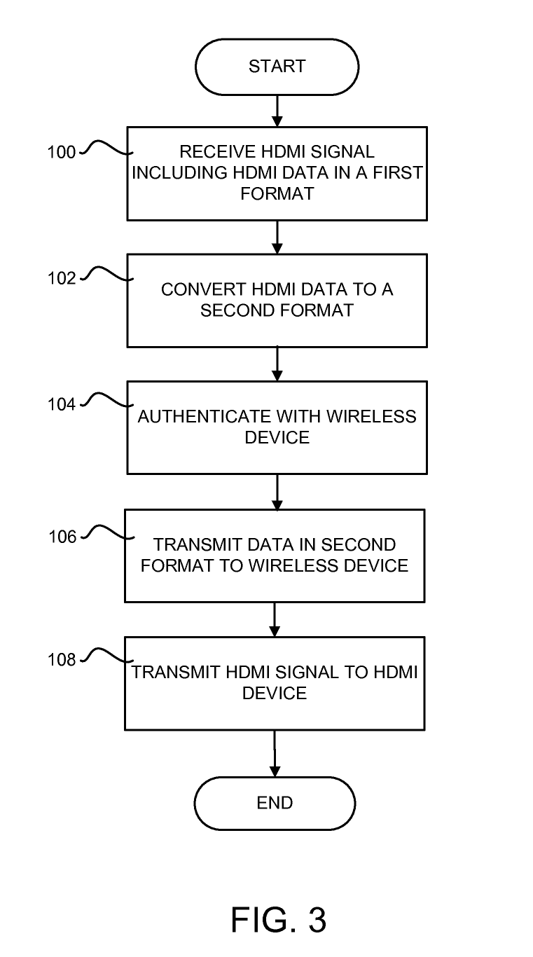

FIG. 3 is a flow chart of an exemplary process for transmitting a signal based on an HDMI signal, in accordance with the principles of the present invention. In block 100, device 12 receives an HDMI signal including HDMI data in a first format via first HDMI interface 32. Methods for receiving an HDMI signal are known and are beyond the scope of this invention. The signal may include audio and visual data encrypted using High-bandwidth Digital Content Protection (HDCP). The data in the HDMI signal is converted to a second format (Block 102). Device 12 may decrypt data before transmitting data to wireless device 18. Device 12 may convert the data to a format usable by wireless device 18. Device 12 may authenticate with wireless device 18 to initiate transmission of the converted data to wireless device 18 (Block 104). Device 12 may receive from wireless device 18 user identification data and a password. Device 12 may verify that wireless device 18 is authorized to receive data from device 12. The converted data may be wirelessly transmitted to wireless device 18 (Block 106). The HDMI signal may be transmitted to an HDMI device via second HDMI interface 34 (Block 108). Although blocks 102, 104 and 108 are shown in FIG. 3 in a particular order, the invention is not limited to such.

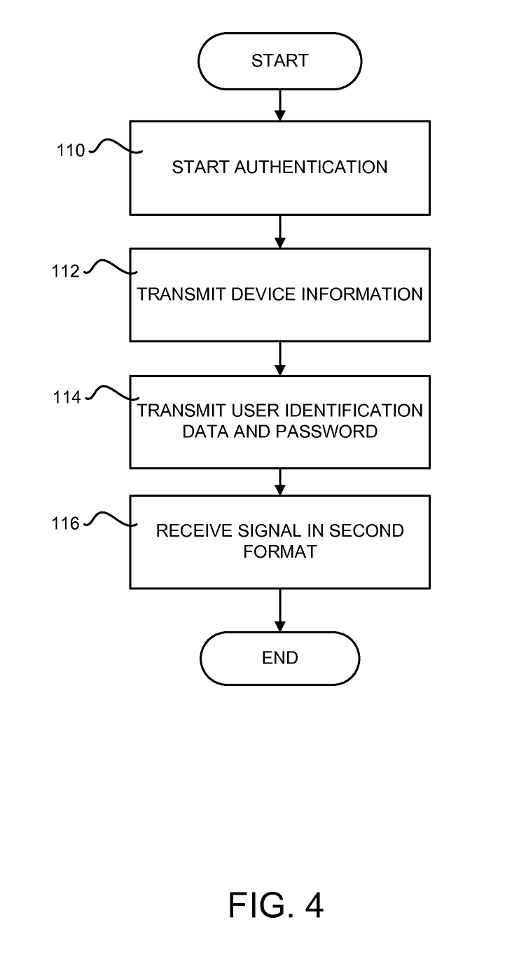

FIG. 4 is a flow chart of an exemplary process in which wireless device 18 receives a signal from device 12, in accordance with the principles of the present invention. Wireless device 18 may start authentication procedures with device 12 (Block 110). During authentication, wireless device 18 may send to device 12 information associated with wireless device 18 (Block 112). Additionally, wireless device 18 may send user identification data and a password to device 12 (Block 114). Wireless device 18 receives a signal from device 12 (Block 116). The signal may be based on an HDMI signal that has been converted to a second format usable by wireless device 18. Blocks 112 and 114 are optional and the blocks do not need to be executed in the order shown

Of note, although the present invention is described with reference to HDMI and HDCP, the invention is not limited to such. It is contemplated that the present invention can be implemented using any authentication and encryption scheme between a media source and destination and can also be implemented using any suitable physical communication interface arrangement, e.g., DVI, RJ45, etc.

The present invention can be realized in hardware or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile, non-volatile, non-transitory computer readable storage device.

Computer program, software or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method, comprising:
receiving a first signal from a source via a first interface, the first signal including data in a first format;
converting the data to a second format;
wirelessly transmitting the converted data to a wireless device; and
transmitting the first signal to a multimedia destination via a second interface.

2. The method of claim 1, wherein the first signal is a High-Definition Multimedia Interface (HDMI) signal, the source is an HDMI source, the first interface is a first HDMI interface and the second interface is a second HDMI interface.

3. The method of claim 2, wherein the HDMI signal received from the HDMI source includes data encrypted using High-bandwidth Digital Content Protection (HDCP), and converting the data to the second format further includes decrypting the data.

4. The method of claim 2, wherein the second format is compatible with the wireless device.

5. The method of claim 2, further comprising:
receiving a unique key associated with the wireless device; and
determining whether the wireless device is authorized to receive the converted data based at least in part on the unique key.

6. The method of claim 2, further comprising:
storing identification information associated with the wireless device; and
determining whether the wireless device is authorized to receive the converted data based at least in part on the identification information.

7. The method of claim 2, wherein the data is converted by encrypting the converted data using High-bandwidth Digital Content Protection (HDCP).

8. A device, comprising:
a first multimedia interface, the first multimedia interface configured to receive a multimedia signal from a multimedia source, the multimedia signal including data in a first format;
a processor in communication with the first multimedia interface, the processor configured to convert the data to a second format;
a wireless transmitter in communication with the processor, the wireless transmitter configured to wirelessly transmit the converted data for receipt by a wireless device; and
a second multimedia interface in communication with the processor, the second multimedia interface configured to transmit the multimedia signal for receipt by a multimedia destination.

9. The device of claim 8, wherein the first multimedia interface is a first High-Definition Multimedia Interface (HDMI) interface, the second multimedia interface is a second HDMI interface, and the multimedia signal is a HDMI signal.

10. The device of claim 9, wherein the data is encrypted using High-bandwidth Digital Content Protection (HDCP), and converting the data to the second format further includes decrypting the data.

11. The device of claim 9, wherein transmitting the HDMI signal using the second HDMI interface includes passing HDCP authentication information received from the HDMI source to the HDMI destination.

12. The device of claim 9, wherein the processor is further configured to perform:
receiving a unique key associated with the HDMI destination; and
determining whether the HDMI destination is authorized to receive the HDMI signal based at least in part on the unique key.

13. The device of claim 9, further comprising a memory, the memory storing identification information associated with the wireless device; and
the processor further:
determines whether the wireless device is authorized to receive the converted data based at least in part on the identification information; and
causes the converted date to be wirelessly transmitted for reception by the wireless device if the wireless device is determined to be authorized to receive the converted data.

14. The device of claim 9, wherein the processor further:
receives a user name and password from the wireless device;
authenticates the wireless device; and
transmits the data in the second format if the wires device has been successfully authenticated.

15. The device of claim 9, wherein converting the data to a second format further comprises encrypting the converted data using High-bandwidth Digital Content Protection (HDCP).

16. A computer readable storage medium having stored therein computer readable instructions that, when executed by a processor, cause the processor to perform a method comprising:
receiving a High-Definition Multimedia Interface (HDMI) signal from an HDMI source via a first HDMI interface, the HDMI signal including data in a first format;
converting the data to a second format;
wirelessly transmitting the converted data to a wireless device; and
transmitting the HDMI signal to an HDMI destination via a second HDMI interface.

17. The computer readable storage medium of claim 16, wherein the data is encrypted using High-bandwidth Digital Content Protection (HDCP), and converting the data to the second format further includes decrypting the data.

18. The computer readable storage medium of claim 16, wherein the second format is compatible with the wireless device.

19. The computer readable storage medium of claim 16, the method further comprising:
storing identification information associated with the wireless device; and
determining whether the wireless device is authorized to receive the converted data based at least in part on the identification information.

20. The computer readable storage medium of claim 16, wherein the method further comprises:
receiving a unique key associated with the HDMI destination; and
determining whether the HDMI destination is authorized to receive the HDMI signal based at least in part on the unique key.

21. The computer readable medium of claim 16, wherein transmitting the HDMI signal to an HDMI destination via the second HDMI interface includes passing HDCP authentication information received from the HDMI source to the HDMI destination.
